(19) United States
(12) Patent Application Publication
(10) Pub. No.: US 2021/0364166 A1
(43) Pub. Date: Nov. 25, 2021

(54) FLAME TRANSFER FUNCTION MEASUREMENT SYSTEM FOR PREDICTING AND REDUCING COMBUSTION INSTABILITY

(71) Applicant: Seoul National University R&DB Foundation, Seoul (KR)

(72) Inventors: Jinhyun BAE, Seoul (KR); Youngbin YOON, Seoul (KR)

(73) Assignee: Seoul National University R&DB Foundation, Seoul (KR)

(21) Appl. No.: 16/882,701

(22) Filed: May 25, 2020

(51) Int. Cl. F23N 5/16; F23N 5/24; F01D 17/08; F23N 1/00

(52) U.S. Cl. CPC F23N 5/16; F23N 5/245; F23R 2900/00013; F23N 1/002; F01D 17/08

(57) ABSTRACT

The present disclosure relates to a flame transfer function measurement system for predicting and reducing combustion instability in which is possible to obtain at once the flame transfer function in the full frequency range by conducting the test while automatically converting the range of the frequency to be measured. Accordingly, there is no need to conduct the test repeatedly while changing the frequency, and therefore, there is an effect of obtaining the flame transfer function in the full frequency range in a very short period of time.

### 1. FIELD

The present disclosure relates to a flame transfer function measurement system for predicting and reducing combustion instability.

### 2. BACKGROUND

Combustion instability, which is one of the biggest obstacles in the development of engines installed on rockets, etc., means a phenomenon in which, due to the interaction of pressure perturbation and heat release rate perturbation inside the combustion chamber, the two perturbations are greatly amplified. A large pressure perturbation inside the combustion chamber causes destruction of the combustion chamber, and a large heat release rate perturbation can cause fatigue failure due to heat.

The combustion instability as described above occurs due to the combination of intrinsic properties of the flame and acoustic properties of the combustion chamber. Therefore, if the intrinsic properties of the flame are known, the combustion instability can be avoided by preventing the interaction between the two by either changing the intrinsic properties of the flame by changing the combustion conditions, or by changing the acoustic properties by changing the structure of the combustion chamber.

The intrinsic properties of the flame can be known from the flame transfer function. The flame transfer function is dependent on the frequency of the flow rate. According to a conventional apparatus for measuring a flame transfer function, the test is conducted for one fixed frequency to output a result value, and then, after changing the frequency, the test is repeated again, which is quite cumbersome.

### SUMMARY

A purpose of the present disclosure is to resolve the aforementioned problems of prior art, that is, to provide a flame transfer function measurement system for predicting and reducing combustion instability, that may obtain at once the flame transfer function in the full frequency range by conducting the test while automatically converting the range of the frequency to be measured.

The aforementioned purpose is achieved by a flame transfer function measurement system for predicting and reducing combustion instability, according to the present disclosure, that includes an accommodation unit for accommodating a fluid; a combustion unit for combusting the fluid being supplied from the accommodation unit, and generating a flame; a perturbation unit for receiving input of frequency information and heat release frequency perturbation information, measuring a flow rate of the fluid being supplied from the accommodation unit to the combustion unit and generating flow rate information, approving perturbation to the fluid being supplied from the accommodation unit to the combustion unit, but adjusting a perturbation frequency of the fluid and a perturbation intensity of the fluid based on the input frequency information and heat release frequency perturbation information; a camera unit for photographing the flame being generated in the combustion unit and generating combustion generation radical self-luminescence information; a light detection unit for measuring a light being generated in the flame being generated in the combustion unit and generating heat release rate information; and a computation unit for computing the flame transfer function based on the flow rate information, the combustion generation radical self-luminescence information, and the heat release rate information.

Further, the computation unit may output a gain value and a phase of the flame transfer function.

Further, the computation unit may be a computation-process such that the phase of the flame transfer function can be continuously changed.

Further, the frequency information may include information on a range of the frequency to be measured, and information on an interval of the frequency to be measured.

According to the present disclosure, it is possible to obtain at once the flame transfer function in the full frequency range by conducting the test while automatically converting the range of the frequency to be measured. Accordingly, there is no need to repeatedly conduct the test while changing the frequency, and therefore, there is an effect of obtaining the flame transfer function in the full frequency range at a very short period of time.

Meanwhile, the effects of the present disclosure are not limited to the aforementioned effects, and thus, various effects may be included within a range obvious to those skilled in the art from the description hereinbelow.

### BRIEF DESCRIPTION OF THE DRAWINGS

FIG. 1 is an overall view of a flame transfer function measurement system for predicting and reducing combustion instability according to an embodiment of the present disclosure;

FIG. 2 is a view of connection between components of the flame transfer function measurement system for predicting and reducing combustion instability according to an embodiment of the present disclosure;

FIG. 3 is a graph illustrating the flame transfer function being obtained by the flame transfer function measurement system for predicting and reducing combustion instability according to an embodiment of the present disclosure; and

FIG. 4 is a graph illustrating the relationship between a combustion instability frequency and a flame transfer function frequency being obtained by the flame transfer function measurement system for predicting and reducing combustion instability according to an embodiment of the present disclosure.

### DETAILED DESCRIPTION

Hereinafter, some embodiments of the present disclosure will be described in detail through exemplary drawings. It should be noted that in adding reference numerals to the components of each drawing, the same components have the same reference numerals as possible, even if they are displayed on different drawings.

Further, in describing the embodiments of the present disclosure, when it is determined that detailed descriptions of related well-known configurations or functions interfere with understanding of the embodiments of the present disclosure, detailed descriptions thereof will be omitted.

In addition, in describing the components of the embodiments of the present disclosure, terms such as first, second, A, B, (a), and (b) may be used. These terms are only for distinguishing the component from other components, and the nature, order, or sequence of the component is not limited by the term.

Hereinbelow, the flame transfer function measurement system for predicting and reducing combustion instability according to an embodiment of the present disclosure will be described in detail with reference to the drawings attached.

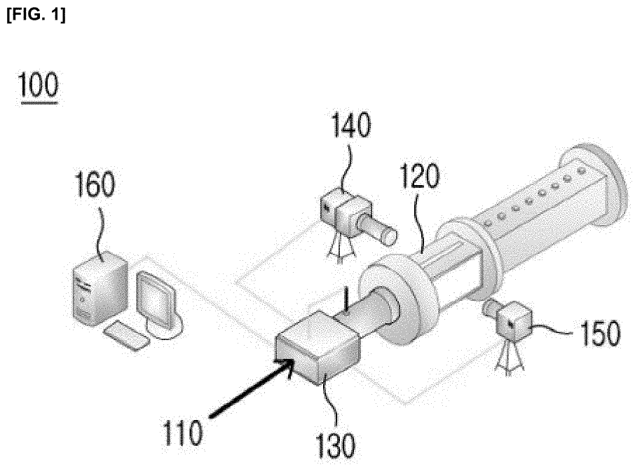

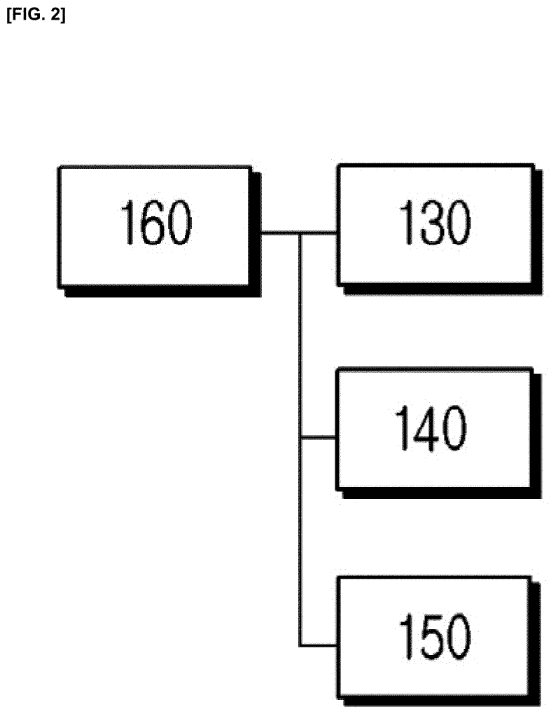

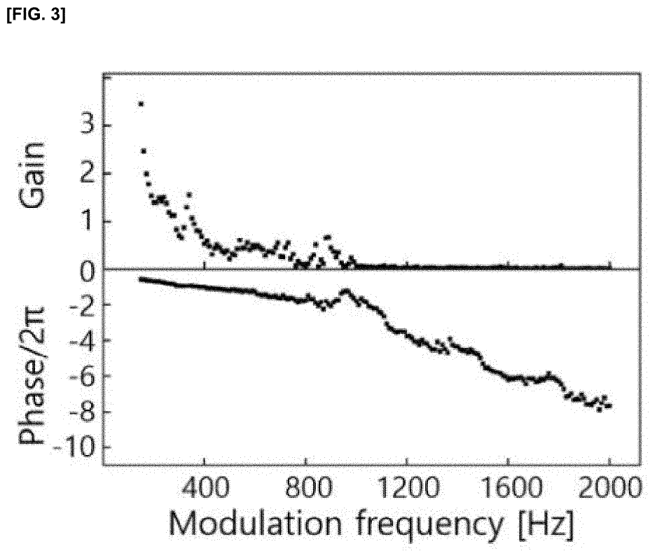

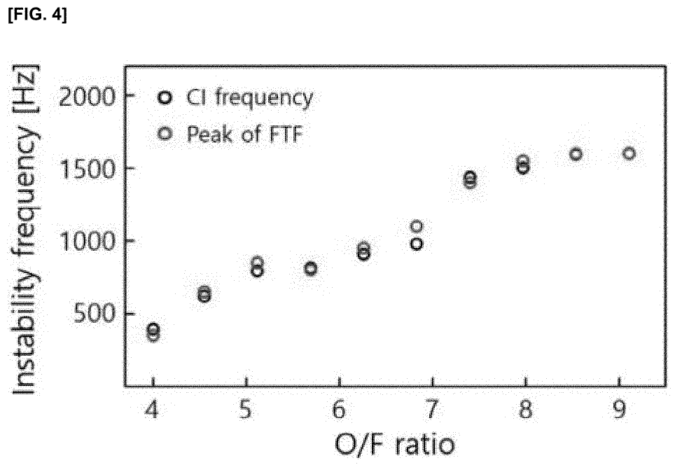

FIG. 1 is an overall view of a flame transfer function measurement system for predicting and reducing combustion instability according to an embodiment of the present disclosure; FIG. 2 is a view of connection between components of the flame transfer function measurement system for predicting and reducing combustion instability according to an embodiment of the present disclosure; FIG. 3 is a graph illustrating the flame transfer function being obtained by the flame transfer function measurement system for predicting and reducing combustion instability according to an embodiment of the present disclosure; and FIG. 4 is a graph illustrating the relationship between a combustion instability frequency and a flame transfer function frequency being obtained by the flame transfer function measurement system for predicting and reducing combustion instability according to an embodiment of the present disclosure.

According to the flame transfer function measurement system for predicting and reducing combustion instability according to an embodiment of the present disclosure 100, a flame transfer function is computed, which may be expressed as in [Math Equation 1] below.

$$FTF ( ω ) = \frac{{q}^{′} / \overline{q}}{{u}^{′} / \overline{u}} \qquad [ Math Equation 1 ]$$

Here, FTF=Flame Transfer Function, q′√q=Flux Perturbation, and u″√u=Heat Release Frequency Perturbation

When a gain value and a phase of the flame transfer function as the one described above are known, the characteristics of the flame can be known, and using those characteristics, it is possible to comprehend the characteristics of the combustion instability. Therefore, through the flame transfer function measurement system for predicting and reducing combustion instability according to an embodiment of the present disclosure 100, flow rate perturbation information per frequency and heat release frequency perturbation information of the fluid must be derived respectively.

As illustrated in FIG. 1 and FIG. 2, the flame transfer function measurement system for predicting and reducing combustion instability according to an embodiment of the present disclosure 100 includes an accommodation unit 110, a combustion unit 120, a perturbation unit 130, a camera unit 140, a light detection unit 150, and a computation unit 160.

The accommodation unit 110 is for providing a space in which the fluid may be accommodated, and the accommodation unit 110 is connected to the perturbation unit 130. When the accommodation unit 110 supplies the fluid to the perturbation unit 130, the fluid is excited under set conditions in the perturbation unit 130 and then transferred to the combustion unit 120. Here, the fluid may include fuels and oxidizers.

The combustion unit 120 is for combusting the fluid being supplied from the accommodation unit 110 and generating a flame, and the combustion unit 120 is connected to the perturbation unit 130 to be supplied with the excited fluid.

The combustion unit 120 may be partially made of a transparent Quartz material so that the camera unit 140 and light detector can check the flame.

The perturbation unit 130 is for exciting the fluid being transferred from the accommodation unit 110, and then transferring the excited fluid to the combustion unit 120, and the perturbation unit 130 is connected to the accommodation unit 110 and the combustion unit 120, respectively. By the perturbation unit 130 described above, the fluid may be excited at a specific frequency.

Further, the perturbation unit 130 measures the flow rate of the fluid being transferred from the accommodation unit 110 to the combustion unit 120, and generates flow rate information. The generated flow rate information is transmitted to the computation unit 160, and when computing the flame transfer function in the computation unit 160, the generated flow rate information is used as flux perturbation information.

As described above, since the perturbation unit 130 performs the function of measuring the flow rate of the fluid while exciting the fluid at the same time, according to the perturbation unit 130, compared to prior art where separate apparatuses had to be used, respectively, an effect of simplifying the entire system is expected.

Meanwhile, in the perturbation unit 130, frequency information and heat release frequency perturbation information are input by an operator.

Here, the frequency information includes information on the range of the frequency to be measured and information on the interval of frequency to be measured. The heat release frequency perturbation information corresponds to the denominator in the flame transfer function as indicated in [Math Equation 1], and therefore, when the heat release frequency perturbation information changes, the value of the flame transfer function will change due to the nonlinearity, and therefore, this value must be fixed in the tests.

The perturbation unit 130 adjusts the intensity of perturbation of the fluid as the fluid is excited while the frequency is changed at a certain interval based on the input frequency information and heat release frequency perturbation information, thereby adjusting the heat release frequency perturbation to be fixed.

According to such a perturbation unit 130, the test can be conducted while the range of the frequency to be measured is automatically converted, and therefore, it is possible to expect an effect of obtaining the flame transfer function in full frequency range, at once. Accordingly, there is no need to repeatedly conduct the test while changing the frequency, and therefore, there is an effect of obtaining the flame transfer function in the full frequency range in a very short period of time.

The camera unit 140 is for photographing the flame being generated in the combustion unit 120 and generating combustion generation radical self-luminescence information, and the camera unit 140 is disposed at one side of the combustion unit 120, and is electrically connected to the computation unit 160.

The light detection unit 150 is for measuring the light being generated from the flame being generated in the combustion unit 120 and then generating the heat release rate information, and the light detection unit 150 is disposed to face the camera unit 140 having the combustion unit 120 therebetween, and the light detection unit 160 is electrically connected to the computation unit 160.

The combustion generation radical self-luminescence information being generated from the camera unit 140 and the heat release rate information being generated from the light detection unit 150 are transmitted to the computation unit 160, and the transmitted information is used to generate the heat release frequency perturbation information in the computation unit 160.

The computation unit 160 is for computing the flame transfer function based on the flow rate information, combustion generation radical self-luminescence information and heat release rate information, and the computation unit 160 is electrically connected to the perturbation unit 130, the camera unit 140 and the light detection unit 150, respectively.

Such a computation unit 160 may be provided as a computing device such as a Personal Computer (PC). In the computation unit 160, based on the flow rate information, the flux perturbation information on a specific frequency of the fluid is generated, and based on the combustion generation radial self-luminescence information and the heat release rate information, the heat release frequency perturbation information on the specific frequency of the fluid is computed, and then the flame transfer function is derived.

Here, the computation unit 160 is configured to perform, record, and store a plurality of computations in conjunction with the perturbation unit 130 that automatically converts the frequency range of fluid excitation, and thus, according to the computation unit 160, the test can be conducted as the range of the frequency to be measured is automatically converted, and therefore, it is possible to expect an effect of obtaining the flame transfer function in the full frequency range, at once. Accordingly, there is no need to conduct the test repeatedly while changing the frequency, and therefore, there is an effect of obtaining the flame transfer function in the full frequency range in a very short period of time.

Meanwhile, the graph output according to the computation unit 160 is a graph for a gain value and phase of the flame transfer function per frequency, and here, since the phase is computed from−n to n in radian units, when the phase becomes smaller than −n, it will increase by 2n, and thus, in the next frequency, there will be a problem that the phase will be displayed in-continuously. Therefore, it is desirable that the computation unit 160 is operated such that, in the case mentioned above, the computation unit 160 postprocesses to automatically compute 2π or −2π, so that the gain value and phase of the flame transfer function are changed continuously per frequency.

According to such a computation unit 160, as illustrated in FIG. 3, a graph can be output in which the gain value and phase of the flame transfer function per frequency are changed continuously, and as illustrated in FIG. 4, a graph can be output that shows the relationship between the combustion instability frequency and the flame transfer function frequency.

The gain value of the flame transfer function generated according to the computation unit 160 represents the size of the heat release rate perturbation inside the combustion unit 120 regarding a certain external perturbation, and the gain value being large means that the flame is most instable in the corresponding frequency. Therefore, by designing a combustion unit 120 in which such a frequency does not correspond to the resonance frequency of the combustion unit 120, or by designing a combustion unit 120 in which the combustion conditions are changed so that the frequency where the peak of the gain value is formed does not correspond to the resonance frequency of the combustion unit 120, interaction between them can be prevented, and therefore, the combustion instability can be avoided.

According to the flame transfer function measurement system for predicting and reducing combustion instability according to an embodiment of the present disclosure 100, that includes the accommodation unit 110, the combustion unit 120, the perturbation unit 130, the camera unit 140, the light detection unit 150, and the computation unit 160, described above, it is possible to obtain the flame transfer function in the full frequency range at once by conducting the test while automatically converting the range of the frequency to be measured. Accordingly, there is no need to conduct the test repeatedly while changing the frequency, and therefore, there is an effect of obtaining the flame transfer function in the full frequency range in a very short period of time.

Hereinabove, even if all the components constituting the embodiment of the present disclosure are described as being combined or operated as one, the present disclosure is not necessarily limited to these embodiments. That is, within the purpose scope of the present disclosure, one or more of all the components may be selectively combined and operated.

In addition, the terms “include”, “consist” or “have” as described above mean that the corresponding component can be intrinsic unless specifically stated to the contrary. It should be interpreted that other components may be included rather than excluded. All terms, including technical or scientific terms, have the same meaning as generally understood by a person skilled in the art to which the present disclosure pertains, unless otherwise defined. Commonly used terms, such as predefined terms, should be interpreted as being consistent with the contextual meaning of the related art, and are not to be interpreted as ideal or excessively formal meanings unless explicitly defined in the present disclosure.

And the above description is merely illustrative of the technical idea of the present disclosure, and those skilled in the art to which the present disclosure pertains will be able to make various modifications and variations without departing from the essential characteristics of the present disclosure.

Therefore, the embodiments disclosed in the present disclosure are not intended to limit the technical spirit of the present disclosure, but to explain, and the scope of the technical spirit of the present disclosure is not limited by these embodiments. The scope of protection of the present disclosure should be interpreted by the following claims, and all technical spirits within the equivalent range should be interpreted as being included in the scope of the present disclosure.

What is claimed is:

1. A flame transfer function measurement system for predicting and reducing combustion instability, comprising:
an accommodation unit for accommodating a fluid;
a combustion unit for combusting the fluid being supplied from the accommodation unit, and generating a flame;
a perturbation unit for receiving input of frequency information and heat release frequency perturbation information, measuring a flow rate of the fluid being supplied from the accommodation unit to the combustion unit and generating flow rate information, approving perturbation to the fluid being supplied from the accommodation unit to the combustion unit, but adjusting a perturbation frequency of the fluid and a perturbation intensity of the fluid based on the input frequency information and heat release frequency perturbation information;
a camera unit for photographing the flame being generated in the combustion unit and generating combustion generation radical self-luminescence information;
a light detection unit for measuring a light being generated in the flame being generated in the combustion unit and generating heat release rate information; and
a computation unit for computing the flame transfer function based on the flow rate information, the combustion generation radical self-luminescence information, and the heat release rate information.

2. The flame transfer function measurement system for predicting and reducing combustion instability, according to claim 1,
wherein the computation unit outputs a gain value and a phase of the flame transfer function.

3. The flame transfer function measurement system for predicting and reducing combustion instability, according to claim 2,
wherein the computation unit is a computation-processes such that the phase of the flame transfer function can be continuously changed.

4. The flame transfer function measurement system for predicting and reducing combustion instability, according to claim 1,
wherein the frequency information comprises information on a range of the frequency to be measured, and information on an interval of the frequency to be measured.
